(19) United States
(12) Patent Application Publication
(10) Pub. No.: US 2011/0123069 A1
(43) Pub. Date: May 26, 2011

(54) Mapping Property Values Onto Target Pixels Of An Image

(76) Inventors: Pavel Kisilev, Maalot (IL); Daniel Freedman, Zichron yaakov (IL)

(21) Appl. No.: 12/622,779

(22) Filed: Nov. 20, 2009

(51) Int. Cl. G06K 9/00

(52) U.S. Cl. 382/106

(57) ABSTRACT

A computer implemented method of mapping values of source pixels (c(x)ₛ) of a source image 2 onto target pixels (c(x)ₜ) of a target image 4. In one image (2) or in respective images (2, 4) two different groups (Rₛ, Rₜ) of pixels are selected to be representative of target and source pixels according to their property values. Within the image or images, target pixels (xεT) and source pixels (xεS) are selected which match the selected representative target and source pixels according to the property values thereof. The distributions of values of properties associated with the source pixels and target pixels are calculated. New property values are mapped onto the target pixels according to a transform which minimises an overall closeness measure between the source distribution and the target distribution.

### BACKGROUND

The paper by G Greenfield and D House, Image recolouring induced by palette colour associations, Journal of WSCG, 11(1), 189-196, 2003, describes how to recolour a target image according to a colour scheme from a source image. The recolouring scheme involves a pyramid analysis of the source and target images. The colour palette of the source image is constructed and then transferred automatically to the target image. To construct the palette the source image is segmented into groups of pixels with similar colour; colours are deemed to be identical if their Euclidean Distance does not exceed a threshold value. Colours are partitioned into subsets of similar shading. The colour palette for an image is constructed by choosing most typical colours from the segments. Colour transfer is computed by transferring the colour of the largest area of the source image to the largest area of the target. The colours of other areas are transferred by matching the segment areas between source and destination segments and finding the closest Euclidean match between pairs of colours from the source and destination segments. Only chroma components are transferred.

Features and advantages of illustrative embodiments of the invention will become apparent from the following description of embodiments of the invention, given by way of example only, which is made with reference to the accompanying drawings.

### BRIEF DESCRIPTION OF THE FIGURES

FIG. 1 is a schematic diagram showing a source region and a target region in which the photometric values of pixels in the source region are to be mapped on to pixels in the target region;

FIG. 2 is a schematic flow diagram of methods of detecting source and target regions in an image or images;

FIG. 3 is a schematic diagram illustrating the relationships of pixels, histogram bins, a neighbourhood of bins and flow;

FIG. 4 is a flow diagram illustrating a method of mapping photometric values of source pixels onto target pixels;

FIG. 5 is a flow diagram of an alternative method of detecting source and target regions of an image; and

FIG. 6 is a schematic block diagram of a digital image processing system.

### DETAILED DESCRIPTION OF ILLUSTRATIVE EMBODIMENTS OF THE INVENTION

### Overview of Colour Copy and Paste in Accordance with an Embodiment of the Present Invention

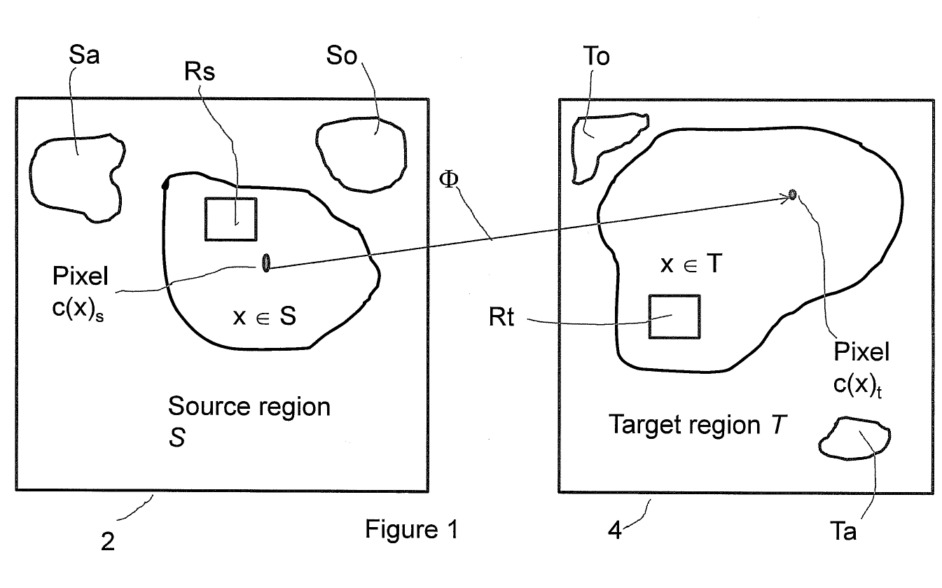

Consider FIG. 1 which is a simplified schematic illustration of a digital colour image of a scene. In the embodiments of the invention described herein, colour is represented in L, a, b colour space, However, the invention is not limited to L, a, b space and other colour representations may be used including by way of example: RGB; CMYK; and CIELUV.

In the present embodiment, the source region S and the target region T of FIG. 1 are regions of different colour. The regions may be in different images 2 and 4. Alternatively, the regions S and T may be different parts of the same image. For convenience of description, we assume the source and target regions are in different images 2 and 4. Each image has other regions, schematically represented by So and To and Sa and Ta.

Referring to FIG. 1, as an illustrative example, it is desired to change the colour of the target region T of image 4 to be the same as that of the source region S of the image 2. That is achieved by an embodiment of the present invention. In the embodiment a small area Rt, referred to as a target area, within the target region T, and a small area Rs, referred to as a source area, within the source region S are selected. The embodiment automatically detects the source region S or regions, e.g. regions S and Sa, of the source image 2 having the same colour as the selected source area Rs and also automatically detects the region T or regions e.g. T and Ta of the target image 4 having the same colour as the selected target area Rt. Any region of the source image such as So having a different colour to the source area Rs is omitted from the detected regions. Likewise, any region of the target image such as Ro having a different colour to the target area Rt is omitted from the detected regions The detection results in a map of the detected target region(s) T and Ta omitting other region(s) e.g. To of different colour to the target region T. Having detected the source and target regions, the colour of the target region(s) is/are changed to be the same as the source colour.

An embodiment of the invention is a computer implemented method of mapping values of source pixels (c(x)ₛ) of the source image 2 onto target pixels (c(x)ₜ) of the target image 4. Images 2 and 4 may be parts of the same image. In one image (2) or in respective images (2, 4), two different groups (Rₛ, Rₜ) of pixels are selected to be representative of target and source pixels according to their property values. Within the image or images, target pixels (xεT) and source pixels (xεS) are selected which match the selected representative target and source pixels according to the property values thereof. The distributions of values of photometric properties of the source pixels and target pixels are determined. New property values are mapped onto the target pixels according to a transform (see Equations 1 and 2 below) which minimises an overall closeness measure between the source distribution and the target distribution.

There are two problems to be solved: firstly find the source region S and the target region T; and secondly for each pixel in the target region T, compute a transform such that the transformed collection of pixels in the target region T is in some sense similar to the collection of pixels in the source region.

In formal terms:—
1. Detection: Find two subsets of the image domain X, the source region S and the target region T with S∩T=0: i.e. S and T do not intersect.
2. Transformation: For each pixel xεT, compute a mapping c(x)→Φ(c(x)) such that the collection {Φ(c(x)): xεT} is in some sense similar to the collection {c(x): xεS}.

### Detecting the Source and Target Regions

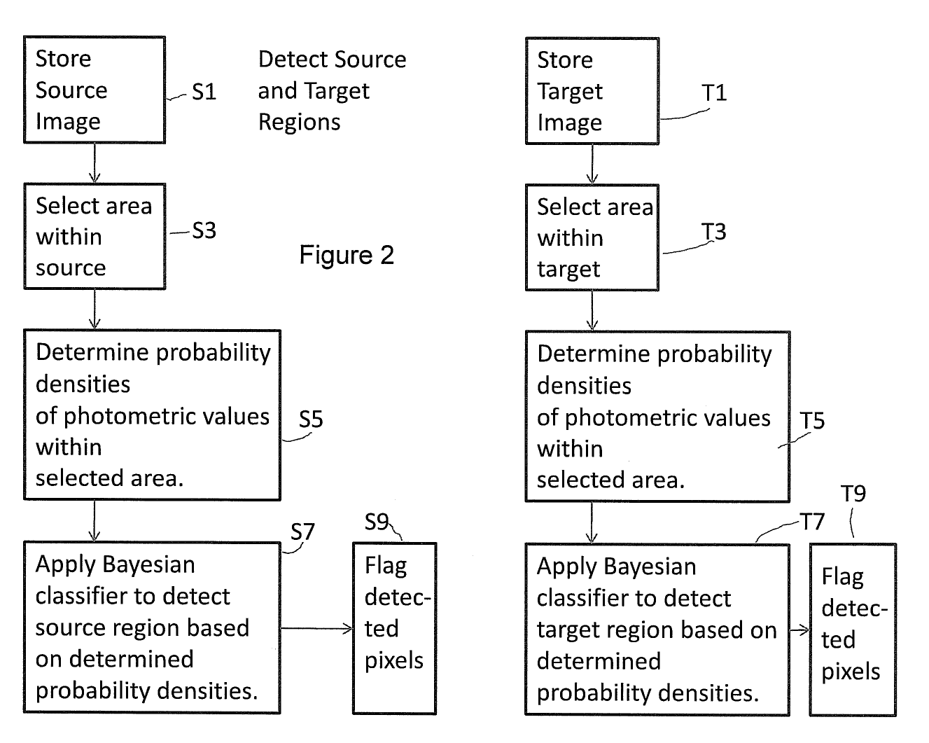

Referring to FIG. 2, the source and target regions are detected in the same way.

In steps S1 and T1, digital images of the source and target are stored.

An area Rs within the source is selected in step S3: see FIG. 1 which shows an example of such an area Rs. Likewise in step T3 an area is selected in the target; FIG. 1A shows an example of such an area Rt.

Step S5 and step T5 determine the probability densities of the photometric values in the selected target and source areas. Once the probability densities of the target and source area are found they are used in steps S7 and T7. Steps S7 and T7 apply a Bayesian classifier to detect the source and target regions, that is regions having, in this example, the same hue as the source and target areas selected in steps S3 and T3. As is evident from FIG. 1, there may be a plurality of separate target regions S, Sa of the same hue. For simplicity in the following we refer to them as a single region. The Bayesian Classifier is applied to each pixel in the images and each pixel is identified as belonging to a source region or to a target region and flagged in steps T9 and S9. In the case of the target image, that produces a map of the target regions T and Ta.

In more detail, the selected source and target areas provide probability densities over c (the photometric value of a pixel) according to

pₛ(c)=p(c|s) and pₜ(c)=p(c|t)

where p(c|s) is the Bayesian conditional probability of c given s and p(c|t) is Bayesian conditional probability of c given t, where s is the source region and t is the target region.

It is assumed that there is a uniform distribution over the parts n of the images which are neither source nor target, i.e. pₙ(c)=p(c|n)=θ, and θ is a constant chosen so that pₙ(c) integrates to 1.

The Bayesian classifier classifies a value of c as belonging to the source if

p(s|c)>max{p(t|c),p(n|c)}

(If there is an equality we are on a boundary of at least two classes.)
From Bayes' Rule we have

p(s|c)=p(c|s)P(s)/p(c)

where P(s) is the probability that a given pixel belongs to the source. Assuming, in the absence of other knowledge, that P(s)=P(t)=P, and P(n)=(1−2P), where P(n) is the probability that a pixel is neither a target pixel nor a source pixel. The Bayesian Classifier then becomes
Choose xεS if pₛ(c|x)>max{pₜ(c|x), θ′}
Choose xεT if p_{f}(c|x)>max {pₛ(c|x), θ′} and
Choose x as neither source nor target in all other cases,
where θ′=(1−2P)θ/P.

Thus given the source and target probability densities pₛ(c) and pₜ(c) from the selected target areas, the Bayesian Classifier depends only on the choice of the single parameter θ′

The probability densities pₛ and pₜ are computed from the photometric values of pixels in the selected areas using histogram bins (as described in the section below describing mapping of source values onto target values).

It is not essential to use selected areas of the target and source to obtain the probability densities. In some circumstances the probability densities may be known a priori from studies of for example the colour density of blue sky, grass or skin.

As indicated by step S9, each pixel of the stored source image is tested against the Bayesian classifier and flagged according to whether or not it is a source pixel. Likewise, as indicated by step T9, each pixel of the stored target image is tested against the Bayesian classifier and flagged according to whether or not it is a target pixel.

### Photometric Transformation

Having found the source and target regions S and T, we wish to transform the photometric properties of the pixels of the target region so the photometric properties of the pixels of the target region closely resemble those of the source region.

Referring to FIG. 1, in formal terms, for each pixel xεT, we wish to computer a mapping c(x)→Φ(c(x) such that the collection {Φ(c(x)): xεT} is in some sense similar to the collection {(c(x): xεS}.

This is not straightforward because the two collections may be quite different. For example, probability distributions over the source and target regions (i.e. over their photometric variables) may have different shapes and/or different numbers of modes and so on, where a mode is a local maximum of a corresponding histogram, or more generally, a local maximum of a probability density.

In this embodiment the computing of the mapping is based on the classic Transportation Problem, and the computation of what is known as the Earth Mover's distance. The Transportation Problem and its solution is disclosed in “The distribution of a product from several sources to numerous locations” by F. Hitchcock in J. Maths, Phys, Mass. Inst. Tech, 20; 224-230, 1941.

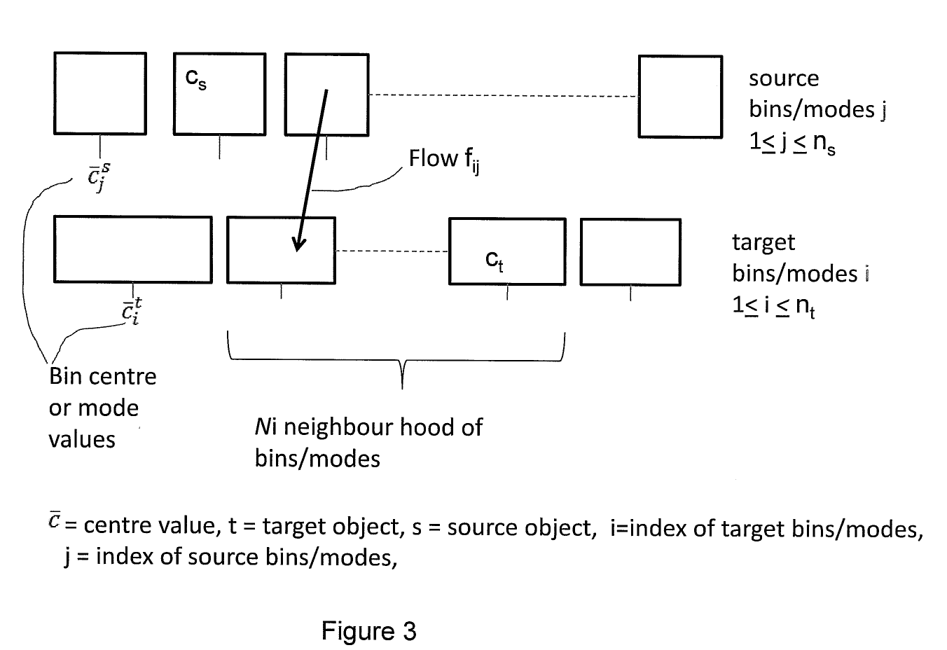

In the following description, the following notation is used. See also FIG. 3.

The superscript or subscript s is a label for the source and the superscript or subscript t is a label for the target.

The source and target probability distributions, which are provided by detecting the source and target regions as discussed above, are represented as a list of histogram bins. (Other representations of probability distributions may be used. As indicated in FIG. 3, modes may be used instead of bins. For convenience of description, the following will refer to bins). The source bins are indexed by j where 1≦j≦nₛ and the target bins are indexed by i, where 1≦i≦nₜ The bins have centre values c̅ᵢ^{t} for target bins and c̅ⱼ^{s} for source bins and corresponding probability masses of p̅ᵢ^{t} and p̅ⱼ^{s}. A photometric variable cₛ resides in a source bin j and a photometric variable cₜ resides in a target bin i.

Let the flow between the target and source distributions be fᵢⱼ, where fᵢⱼ may be thought of as the part of a target bin i which is mapped to a source bin j.

Let the photometric distance between two photometric variables c₁ and c₂ be D(c₁, c₂). In the following example, D is chosen to be defined as the Euclidean distance but other choices may be used in appropriate circumstances as discussed hereinbelow.

Assume initially that the centre values c̅ᵢ^{t} of the target bins are to be mapped onto the centre values c̅ⱼ^{s} of the source bins in such a way that the photometric distance between them is as small as possible. In this example, the target bins range over a plurality of source bins as indicated by way of example in FIG. 3 because it is unlikely that each bin of the target distribution will map neatly on to exactly one bin of the source distribution. However it is necessary to approximately conserve probability for the source and target distributions.

In mathematical terms the optimization problem we wish to solve, for a chosen definition of distance D is:

$${min}_{\{ {f}_{ij} \}} {\sum }_{i = 1}^{{n}_{i}} {\sum }_{j = 1}^{{n}_{s}} {f}_{ij} D ( {\overline{c}}_{i}^{t} , {\overline{c}}_{j}^{s} )$$

$$subject to$$

$${\overline{p}}_{i}^{t} / η \leq {\sum }_{j = 1}^{{n}_{s}} {f}_{ij} \leq η {\overline{p}}_{i}^{t} i = 1 , … , {n}_{t}$$

$${\overline{p}}_{j}^{s} / η \leq {\sum }_{i = 1}^{{n}_{t}} {f}_{ij} \leq η {\overline{p}}_{j}^{s} j = 1 , … , {n}_{s}$$

$${\sum }_{i , j} {f}_{ij} = 1$$

where η>1 is empirically chosen constant (e.g., 3) that controls the strictness of the probability conservation requirement.

In the equation above, the term

$${\sum }_{i = 1}^{{n}_{t}} {\sum }_{j = 1}^{{n}_{s}} {f}_{ij} D ( {\overline{c}}_{i}^{t} , {\overline{c}}_{j}^{s} )$$

is the measure of closeness of two distributions, which are described by means of bin centres ( c̅ᵢ^{t}). The above term is known in the literature as the Earth Mover's Distance It is dependent on D, the Photometric distance. The result of the optimisation according to the Earth Mover's distance is the flow fᵢⱼ which is used in the following equation 1.

The solution is provided by the Transportation Problem by which, in one embodiment, the bin centre value c̅ᵢ^{t} is transformed according to

$${\overline{c}}_{i}^{t} \to \frac{{\sum }_{j = 1}^{{n}_{s}} {f}_{ij} {\overline{c}}_{j}^{s}}{{\sum }_{j = 1}^{{n}_{s}} {f}_{ij}} ≡ Φ ( {\overline{c}}_{i}^{t} ) \qquad Equation 1 )$$

That is we use the flow fᵢⱼ to average over the source bin centres and then normalize. Normalization is done because

Σⱼfᵢⱼ= p̅ᵢ^{t}<<1

This maps the bin centre values of the target distribution onto the bin centre values of the source distribution in such a way that the closeness measure between them is as small as possible. This same transformation may be used to transform the photometric values of target pixels cₜ. This may introduce binning artifacts because Equation 1 is determined only for bin centre values. Two photometric values cₜ may be close together but lie in different bins and so may be mapped to quite different values.

In another embodiment, Equation 1 is used in combination with an interpolation scheme to reduce binning artifacts. A neighbourhood Ni of target bins i is defined for each target bin i where Ni is the union of the bin i and a predetermined number of neighbouring target bins. In this embodiment the Neighbourhood Ni has (2d+1) bins where d is the number of dimensions of the histogram. If the histogram is two-dimensional, Ni=5.

For each target bin i in the neighbourhood N_{[c]}^{t} of a target bin containing a pixel having a photometric value c, a weight wᵢ(c) is calculated based on the distance D(c, c̅ [symbol] [symbol] ) between the value c of the pixel in a target bin and the centre value c̅ [symbol] [symbol] of the target bin i containing the pixel.

$${w}_{i} ( c ) = \frac{ξ ( D ( c , {\overline{c}}_{i}^{t} ) )}{{\sum }_{j ∈ {𝒩}_{{[ c ]}^{t}}} ξ ( D ( c , {\overline{c}}_{j}^{t} ) )}$$

where ξ satisfies ξ′(.)<0 and ξ(0)=∞,
ξ denotes a function, and
ξ′ is the first derivative of the function ξ
We choose ξ(d)=d⁻¹ where d is the argument of the function ξ.
As a result,

$$Φ ( c ) = {\sum }_{j ∈ {𝒩}_{{[ c ]}^{t}}} {w}_{i} ( c ) Φ ( {\overline{c}}_{i}^{t} ) \qquad Equation 2 )$$

The transform of Equation 2 is applied to each pixel flagged by the detecting process of FIG. 2 to indicate it is in the target region.

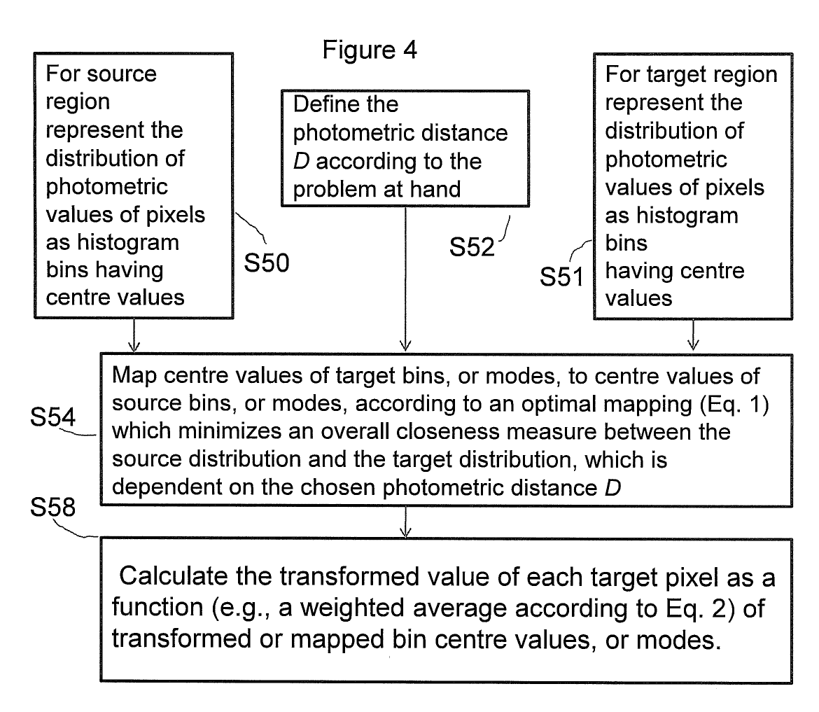

Referring to FIG. 4, in an illustrative implementation, step S50 determines the distribution of photometric values of all pixels in the source region found by the process of FIG. 2. Thus, the photometric values are sorted into histogram bins j where j=1 to nₛ, the bins having centre values c̅ⱼ^{s}. The histogram is a three dimensional histogram for photometric values represented by L, a, b color space.

Likewise, step S51 determines the distribution of photometric values of all pixels in the target region found by the process of FIG. 2. The photometric values are sorted into histogram bins i where i=1 to nₜ, the bins having centre values c̅ᵢ^{t}.

Thus steps S50 and S51 produce distributions represented by the histogram bins of FIG. 3.

Step S52 chooses a definition of distance D according to the property at hand, i.e. according to what property of the pixels is to be mapped from source to target.

Step S54 maps the bin centre values of the target distribution onto the bin centre values of the source distribution according to an optimal mapping, i.e. Equation 1 above, which minimizes an overall closeness measure between the source distribution and the transformed target distribution. In this example the overall closeness measure is the Earth Mover's Distance defined above. The Earth Mover's Distance is dependent on the chosen definition of distance D.

Step S58 calculates a weight wᵢ(c) for each pixel c in each bin i and calculates the transformed value of each flagged target pixel of the target detection map using Equation 2) above.

The foregoing may be used to recolour an image; that is change the colour of a selected target region of a target image based on the colour of a selected source region of a source image, where the source and target regions may be in the same image, or in different images. It may also be used to relight an image, for example change the sky in a target image based on the sky in a source image, where the target and source images are different images. Relighting is a more complex task than recoloring—it may include adjusting colour properties of the whole image.

In both cases, the photometric distance D is based on luminance and chrominance. If (L, a, b) space is used for the photometric values of the pixels, then

D²((L1,a1,b1),(L2,a2,b2))=(L1−L2)²+(a1−a2)²+(b1−b2)².

In another embodiment of the invention, photometric distance is based only on chrominance; that is

D²((L1,a1,b1),(L2,a2,b2))=(a1−a2)²+(b1−b2)².

In a further embodiment, photometric distance is based only on luminance, that is

D²((L1,a1,b1),(L2,a2,b2))=(L1−L2)²,

which may be used where the comparable property in the source and target is lightness.

The definition of distance is chosen in advance according to the property on which the mapping of property from source to target is based.

### Inserting Lightness Characteristics and Retaining Chroma Characteristics

A further embodiment maps photometric values from a target to a source retaining the chroma characteristics of the target while at the same time inserting the lightness characteristics of the source.

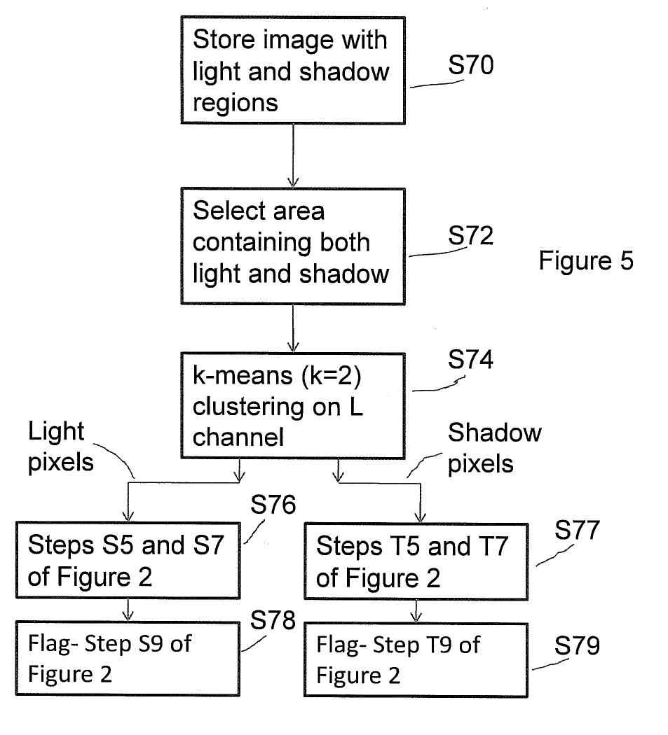

Referring to FIG. 5, for shadow reduction or removal, in step S70, an image is stored. In this case the image has light and shadowed regions. In step S72, an area is selected in the image as indicated by the square as in FIG. 1. The selected area has both light and shadowed parts. In step S74, the pixels of the light part of the selected area and the pixels of the shadowed part are sorted into a light set and a shadowed set using for example k-means clustering operating on the L channel of the (L, a, b) colour space. In this example k=2 but could have other values.

The light pixels are then subjected to the process of steps S5 and S7 of FIG. 2 to determine the probability density thereof and to detect the source region using the Bayesian Classifier. Likewise, the shadowed pixels are subjected to the processes of steps T5 and T7 of FIG. 2 to determine the probability density thereof and to detect the target region using the Bayesian Classifier. The pixels of the source and target regions are flagged in steps S78 and S79 as in steps S9 and T9 of FIG. 2.

The transformation of FIG. 4 is then applied to the image using the photometric distance

D²((L1,a1,b1),(L2,a2,b2))=(a1−a2)²+(b1−b2)²

which determines which of the target pixels having chrominance values a and b, closest to those of the source.

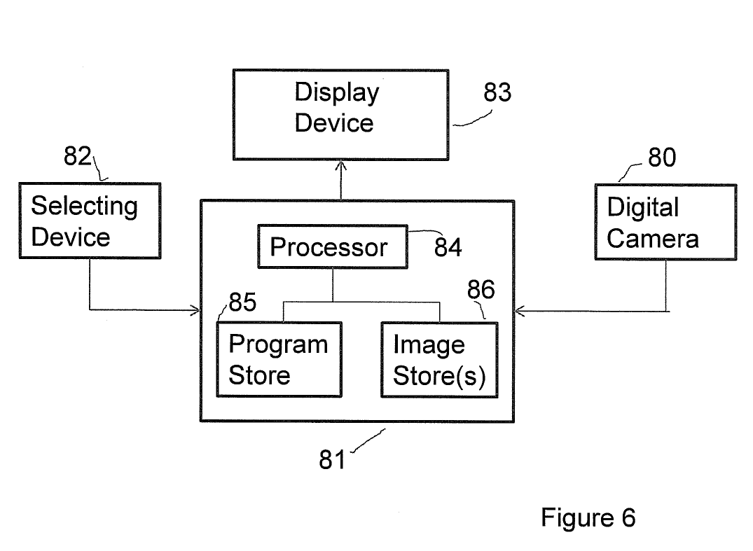

### Digital Image Processing System—FIG. 6

The methods of FIGS. 1 to 5 may be implemented on a digital image processing system an example of which is shown in FIG. 6. The system comprises a digital camera which is for example a stills camera 80. The system has a computer 81 which has a store 86 for storing images to be processed. Those images may be produced by the camera 80 or derived from another source of images. Images are displayed on a display device 83.

The system has a selecting device 82, for example a pointing device, for selecting the source and target areas for use in detecting source and target regions. An example of a pointing device is a mouse.

The computer has a program store 85 which stores computer programs for implementing the methods of FIGS. 1 to 5. A processor cooperates with the pointing device to select the source and target areas and then to automatically detect the source and target regions and change the photometric values of pixels of the target region by mapping photometric values of source pixels onto the target pixels as described above.

The invention further comprises a computer program or set of computer programs which, when run on a suitable image processing system cause the system to implement the methods described above. The program or programs may be stored on a computer readable storage medium. The storage medium may be a hard drive, tape, disc, or electronic storage device. The tape may be a magnetic tape. The disc may be an optical disc, a magnetic disc or a magneto-optical disc for example. The electronic storage may be a RAM, ROM, flash memory or any other volatile or non-volatile memory. The program may be on a carrier which may be a computer readable storage medium or a signal.

The above embodiments are to be understood as illustrative examples of the invention. Further embodiments of the invention are envisaged. For example, the invention has been described by way of example with reference to photometric values of pixels, e.g. hue and brightness. However other properties or parameters of images may be used: for example texture descriptors may be used. Fourier or Wavelet coefficients can be used as texture descriptors.

The invention has been described by way of example with reference to histogram bins to provide a representation of distributions or density estimates. However other representations are known and may be used, for example modes as indicated in FIG. 3. A mode is a local maximum of a probability distribution. The histogram is multi dimensional; for Lab color space it is three dimensional. For modes there would be a three dimensional set of modes for Lab color space.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer implemented method of mapping values of source pixels onto target pixels of an image, comprising the steps of:
selecting in one image or in respective images two different groups of pixels which are representative of target and source pixels according to their property values,
detecting within the image or images, target pixels and source pixels which match the selected representative target and source pixels according to the property values thereof,
determining the distributions of values of properties of the source pixels and target pixels, and
mapping, onto the target pixels, new property values according to a transform which minimises an overall closeness measure between the source distribution and the target distribution.

2. A method according to claim 1, wherein the said closeness measure is the Earth Mover's Distance dependent on a definition of photometric distance between source and target property values chosen according to a particular problem at hand.

3. A method according to claim 1, wherein the said property values of the pixels are the photometric values.

4. A method according to claim 1, wherein the selecting step comprises selecting the two separate groups of pixels as representative of target and source pixels respectively from geometrically separate areas of an image or from respective images according to the property values of the pixels.

5. A method according to claim 1, wherein the selecting step comprises selecting pixels representative of source and target pixels by selecting a group of pixels in an area of an image containing both pixels representative of source pixels and pixels representative of target pixels, and clustering the representative pixels into source and target pixels according to their property values.

6. A method according to claim 1, wherein the detecting step comprises
ascertaining the probability densities of photometric values of the groups of pixels representative of the source and target pixels and
applying a Bayesian classifier to the image or images to detect target and source regions in dependence on the probability densities of the groups of pixels representative of the source and target pixels.

7. A method according to claim 1, wherein the step of determining the distributions of values of properties of the source pixels and target pixels comprises allocating the values to bins of a histogram.

8. A method according to claim 7, wherein the step of determining the distributions of values of properties of the source pixels and target pixels comprises determining the modes of the values.

9. A method according to claim 7, wherein the determining step comprises
allocating the pixels of the source region to source histogram bins having respective centre values,
allocating the pixels of the target region to target histogram bins having respective centre values, and
the mapping step comprises mapping, onto the centre values of the target bins, the centre values of the source bins according to the transform which minimises the overall closeness measure between the source centre values and the transformed target centre values.

10. A method according to claim 9, wherein the step of mapping further comprises weighting each target pixel value with a weight dependent on the distance of the target pixel from the centre value of its target histogram bin.

11. A method according to claim 9, wherein a said target bin i is a member of a neighbourhood Ni of bins and the said weight wᵢ(c) is normalised according to the sum of a function ξ of the distances D of target pixels c from the centres of the target bins in the neighbourhood of bins.

12. A method according to claim 1, wherein the said distance is a Euclidean distance.

13. A method according to claim 9, wherein the said distance is calculated on the basis of chrominance values and/or luminance values.

14. A system for mapping property values onto target pixels of an image, comprising:
a selecting device, and an image processor,
the image processor being responsive to the selecting device to select in one image or in respective images two different groups of pixels which are representative of target and source pixels according to their property values, and
the image processor being further configured to
detect within the image or images target pixels and source pixels which match the selected representative target and source pixels according to the property values thereof,
determining the distributions of values of properties of the source pixels and target pixels, and
map, onto the target pixels, new property values according to a transform which minimises an overall closeness measure between the source distribution and the transformed target distribution.

15. A computer readable storage medium storing a program which when run on a suitable image processor
responds to a selecting device to select in one image or in respective images two separate groups of pixels which are representative of target and source pixels according to their property values,
detects within the image or images target pixels and source pixels which match the selected representative target and source pixels according to the property values thereof,
determining the distributions of values of photometric properties of the source pixels and target pixels, and
maps, onto the target pixels, new property values according to a transform which minimises an overall closeness measure between the source distribution and the target distribution.
